(19) United States
(12) Patent Application Publication
(10) Pub. No.: US 2007/0297280 A1
(43) Pub. Date: Dec. 27, 2007

(54) Double-cone mixer with baffles

(75) Inventors: Martin Kowollik, Bad Fallingbostel (DE); Andreas Rogenhofer, Bad Fallingbostel (DE); Wolfgang Dannhorn, Soltau (DE); Erik-Andreas Klohr, Walsrode (DE)

Correspondence Address: CONNOLLY BOVE LODGE & HUTZ, LLP, P O BOX 2207, WILMINGTON, DE, 19899, US

(73) Assignee: Wolff Cellulosics GmbH & Co. KG, Walsrode (DE)

(21) Appl. No.: 11/820,680

(22) Filed: Jun. 20, 2007

(30) Foreign Application Priority Data
Jun. 27, 2006 (EP) 06013181.0

(51) Int. Cl. B01F 9/02

(52) U.S. Cl. 366/228; 366/225

(57) ABSTRACT

The present invention relates to a novel double-cone mixer, if necessary of enamelled construction, and its use in the production and/or processing of polysaccharide products, preferably based on cellulose.

### CROSS-REFERENCE TO RELATED APPLICATION

The present application in entitled to the benefits of European Patent Application No. 06013181.0 filed Jun. 27, 2006, and that application is incorporated herein in its entirety for all useful purposes.

### BACKGROUND OF THE INVENTION

1. Field of the Invention

The present invention relates to a novel double-cone mixer, optionally of enamelled design, and its use in the production and/or processing of polysaccharide products, preferably based on cellulose.

2. Related Art

The polysaccharide products of industrial importance include cellulose derivatives and in particular methylhydroxyalkyl celluloses, such as methylhydroxyethyl celluloses and methyl-hydroxypropyl celluloses, sodium-carboxymethyl celluloses and ethylhydroxyethyl celluloses. Their production, properties and uses are described for example in Ullmann's Encyclopedia of Industry Chemistry, 5th Edition (1986), Volume A5 pages 461-488, VCH Verlagsgesellschaft Weinheim.

On account of their excellent properties, methylhydroxyalkyl celluloses are employed in the most varied of applications.

On the one hand they are used in industrial applications, e.g. as thickeners, adhesives, binders, dispersants, water-retention agents, protective colloids, stabilizers, suspending agents, emulsifiers, film bonding agents and as consistency regulators and processing aids in mineral and dispersion-based building-material systems. On the other hand they are used in sensitive applications, for example in the production of cosmetic and pharmaceutical preparations, in tablet coating, in eye-drop suspensions, in contact-lens cleaners and the like, or in the production of foodstuffs, in which cellulose ethers are required that are characterized by especially high purity (cf. WO 00/32637). High purity signifies observance of the relevant pharmaceutical regulations, e.g. with respect to batch purity, pH stability, batch homogeneity, solution viscosity. Furthermore, for sensitive applications it is necessary to comply with additional legal regulations and other customer requirements. Thirdly, methylhydroxyalkyl celluloses are used in high-value technical uses, such as in the production of special ceramics and in suspension polymerization, which are also characterized by especially high purity. In these applications high purity means in particular a low level of impurities of a physical nature.

During the production process of the methylhydroxyalkyl celluloses described above it is also necessary for the methylhydroxyalkyl celluloses to be treated in reactors and mixers of various designs, e.g. to ensure the pH stability or homogeneity of a batch or for mixing components in powder or granule form in the methylhydroxyalkyl cellulose which is already in the form of powder or granules.

The corresponding mixing theory is described in the literature, together with many designs of mixers for example, see e.g. Matthias Stiess “Mechanische Verfahrenstechnik” 2nd edition 1995, Springer Verlag or “Ullmann's Encyclopedia of Industry Chemistry”, 5th edition (1988), Volume B2 27 Mixing of Solids, VCH Verlagsgesellschaft Weinheim.

For the production of methylhydroxyalkyl cellulose for sensitive and high-value industrial applications, in view of the special requirements on purity, mixers are preferably used which among other things permit good residual emptying and cleaning of the mixer without any contamination of the components that are to be mixed. Mixers with a moving mixing vessel, in particular double-cone mixers, are especially suitable for this.

As strongly acidic or corrosive substances may also be used in the production of low-viscosity methylhydroxyalkyl cellulose for sensitive and high-value industrial applications, the mixer used, or the materials of which the parts of the mixer that come into contact with the product are comprised, must in addition be resistant to these strongly acidic or corrosive substances. As a rule, enamelled or glazed vessels are used for this in industrial production processes. It is common knowledge in industry that there are special restrictions on the production and industrial use of enamelled or glazed vessels, so that the enamel layer can be applied on the steel wall of the vessel in such a way that it forms an intimate, permanent bond, which is maintained when the vessel is used for its intended purpose. Among other things, it is important for the vessel that is to be enamelled to have a sufficiently simple geometry. Among the various mixer designs, double-cone mixers are particularly suitable for enamelling.

As a rule the double-cone mixers used in industry fulfill the above requirements, with respect to residual emptying, cleanability, possibility of enamelled finish, etc., well enough. A considerable disadvantage, however, is only moderate quality of mixing, especially in the axial direction. This poor mixing behaviour is described in detail for example in “Enhanced mixing in double-cone blenders”, Dean Brone, F. J. Muzzio, Powder Technology 110 (2000) 179-189. It is also described in that work that central, large-area internals can give improved axial mixing. However, these central, large-area internals are not suitable for industrial use, as they represent an obstacle to the properties of the double-cone mixer described above, such as residual emptying, cleanability, possibility of enamelled finish.

For stirring and mixing in a great variety of vessels, such as reactors, mixers, dryers, etc., baffles or flow spoilers are often used in industry. Their use in enamelled reactors is also known in principle and is described in WO 2004/073847. A characteristic feature of the baffles or flow spoilers described is that they produce so-called counter-stirring. Double-cone mixers are not mentioned as reactors in WO 2004/073847. Moreover, there is also no reference to polysaccharide production and processing.

### SUMMARY OF THE INVENTION

There is a pressing need for the provision of a double-cone mixer that is also resistant to aggressive chemical environments, and which, in comparison with conventional, possibly enamelled equipment of the state of the art, ensures improved mixing properties, especially in the axial direction, for economical industrial production of homogeneous, pH-neutral polysaccharide derivatives of very low viscosity, in particular methylhydroxyalkyl celluloses.

It was found that the known drawback of double-cone mixers, with respect to their relatively poor axial mixing, can be significantly improved by the use of baffles, as is already known in stirred tank reactors.

The object of the invention is therefore a double-cone mixer comprising at least one baffle internally.

The invention relates to a double-cone mixer comprising a mixing vessel that can be rotated about the axis of rotation D comprising a drum with a cylindrical middle portion and a cone mounted on each open end of the cylinder, the mixing vessel having flow-spoiling internals inside, which are arranged so that they lead to mixing of the product in the axial orientation relative to the axis of rotation D.

### BRIEF DESCRIPTION OF THE DRAWINGS

FIG. 1 illustrates a schematic of the top view of a double-cone mixer according to the invention;

FIG. 2 illustrates a schematic of the baffles S2 and S2′ according to the invention; and

FIG. 3 illustrates a schematic of the baffles S1 and S1′ according to the invention.

### DETAILED DESCRIPTION OF THE INVENTION

Within the scope of the present invention, double-cone mixers are to be understood as apparatus in which a mixing vessel comprising a drum with a cylindrical middle portion and in each case with an attached cone rotates about a horizontal axis. The arrangement of the vessel walls and the rotation of the drum then usually provide satisfactory uniform, three-dimensional mixing of the product. The product is driven upwards by centrifugal forces and frictional forces, and then slides down, according to its gradient. At higher rotary speeds, the product is lifted farther, and then drops back following a parabolic trajectory. The intensity of mixing increases, at the same time with greatly increasing power consumption. With the simultaneous use of baffles, an improvement of mixing is achieved in the direction of the axis of rotation (=axial direction).

The baffle improves mixing efficiency, for example by increasing turbulence within the product, supplementing the centrifugal and frictional forces arising during rotation and in particular, with a suitable arrangement, forcing an axial direction of flow of the product.

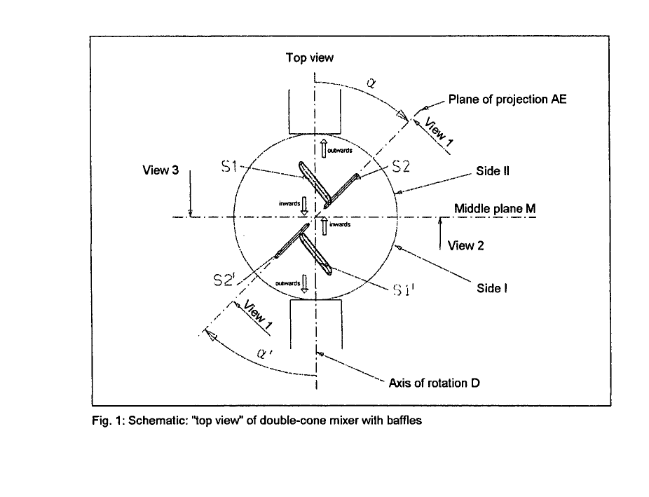

FIG. 1 shows the axis of rotation D of the double-cone mixer and the middle plane M perpendicular to the axis of rotation D (viewed from above) of the double-cone mixer, which divides the double-cone mixer into the two sides I and II. Basically, the baffles can be arranged so that they create an axial conveying action outwards, i.e. away from the middle plane M (cf. FIG. 1), or an axial conveying action inwards, i.e. towards the middle plane M (cf. FIG. 1). Moreover, the baffles can basically be arranged symmetrically or asymmetrically to the middle plane M. Symmetrically means in this context that the baffles are arranged on the two sides I and II of the middle plane M in manner and/or number in such a way that the baffles move the product with in each case equal strength of the conveying action on both sides I and II outwards or with in each case equal strength of the conveying action on both sides I and II inwards. This can be achieved for example by arranging an equal number of similar baffles on both sides I and II of the middle plane M so that these baffles move the product on both sides I and II of the middle plane M, owing to their arrangement, with equal axial conveying action, i.e. strength of feed, and the same direction of feed, in each case axially outwards or in each case axially inwards (cf. FIG. 1). Asymmetrically means in this context that the baffles are arranged on the two sides I and II of the middle plane M in manner and/or number so that the baffles on one side convey the product outwards and the baffles on the other side convey the product inwards. This asymmetric arrangement can be achieved with various combinations of baffles.

Preferably the double-cone mixer according to the invention comprises 1 to 16 baffles, especially preferably 2 to 8, quite especially preferably 4 baffles.

In an especially preferred embodiment the number of baffles used is selected so that both cones each have the same number of baffles and within one cone the flow-spoiling internals are arranged so that in the equal-sized half-spaces, into which a cone is divided by a middle plane M that is perpendicular to the axis of rotation D, there is in each case the same number of baffles.

Preferably, to achieve the desired axial mixing, baffles of types S1 or S2 described below are used, which can be used either individually or in combination with one another in the double-cone mixers according to the invention.

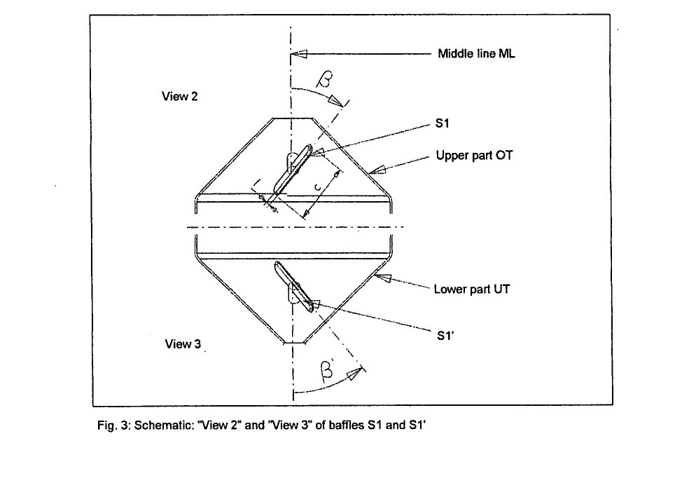

Baffles of type S1 are characterized in that, as in FIG. 1, they are arranged on the wall of the double-cone mixer in alignment with the axis of rotation D and are rotated at an angle β or β′, as shown in FIG. 3, relative to the middle line ML. The intensity of the axial conveying action is adjusted by the size of the angles β and β′ relative to the middle line ML.

For example, as shown in FIG. 3, baffles S1 with mathematically negative orientation of angle β to the middle line ML can be installed in the upper conical part OT of the mixer, whereas baffles S1′ with mathematically positive orientation of angle β′ relative to middle line ML are installed in the opposite lower conical part UT of the mixer. This arrangement is understood within the scope of the present invention as symmetrical arrangement of S1 and S1′ to one another. Such a symmetrical arrangement provides the same direction of feed of S1 and S1′, which is directed either axially outwards or axially inwards, depending on the sense of rotation of the rotational axis of the double-cone mixer.

Theoretically, angles β and β′ can assume absolute values from 0° to 90° depending on the properties of the product being mixed and depending on the purpose of mixing, with 5° to 85°, especially 10° to 70° and quite especially 15° to 50° being preferred.

Basically, angles β or β′ of the baffles used can vary in each case within a double-cone mixer according to the invention, preferably with all baffles rotated through the same angle (absolute value) relative to the middle line ML of the mixer.

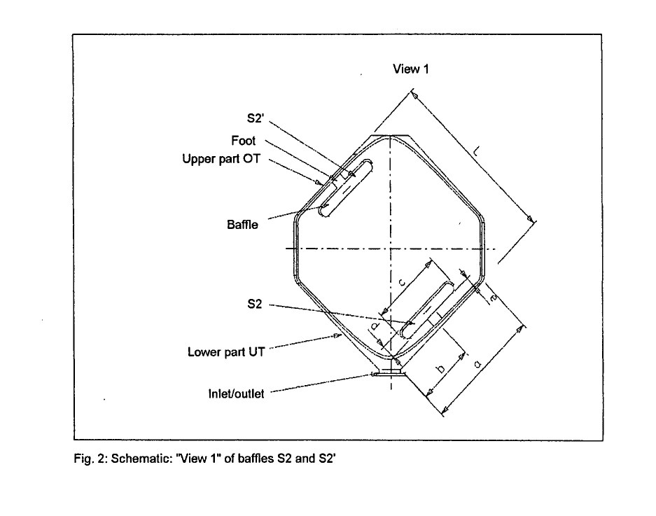

The baffle of type S2 is characterized in that it is positioned on a plane of projection AE that is rotated through angle α or in the case of S2′ through angle α′ relative to the axis of rotation D (cf. FIG. 1). On the plane of projection AE, the baffle of type S2 or S2′ is not rotated. The intensity of the axial conveying action is determined by the magnitude of angles α and α′. The axial direction of feed is determined on the one hand by whether angles α and α′ as shown in FIG. 1 are rotated in the same mathematical direction relative to the axis of rotation D or in the opposite mathematical direction and on the other hand by arrangement of baffles of type S2 in the upper conical part OT or lower conical part UT of the double-cone mixer. In the case of the possible arrangement shown in FIG. 2, S2 is shown in the lower conical part UT with mathematically negative orientation of α and S2′ is shown in the upper conical part OT also with mathematically negative orientation of α′. This symmetrical arrangement of baffles S2 and S2′ in the sense of this invention means that the direction of feed of S2 and S2′ is the same, namely either axially outwards or axially inwards depending on the sense of rotation of the double-cone mixer.

Theoretically, angles α and α′ can assume values from 0° to 90°, and for the boundary case of angles α and α′ of 90°, baffles S2 or S2′ no longer have an axial mixing action. Absolute values for angles α and α from 5° to 85°, especially 10° to 70°, quite especially 20° to 60° are preferred, depending on the properties of the product being mixed and depending on the purpose of mixing.

The baffles S1, S1′, S2 and S2′ shown in FIGS. 1 to 3 are arranged in this example in such a way that overall they form a symmetrical arrangement, i.e. so that all baffles shown here convey outwards (cf. FIG. 1) or all baffles shown here convey inwards (cf. FIG. 1), depending on the sense of rotation of the mixer.

The double-cone mixer described in this invention can be equipped, as described above, with the most varied combinations of baffles of various types, a symmetrical arrangement of baffles with respect to the direction of feed, in which both types S1 and S2 are used, in each case symmetrically, is preferred; especially preferably, a symmetrical arrangement of baffles with respect to direction of feed and intensity of the axial conveying action, in which both types S1 and S2 are used, in each case symmetrically, and in which angles β and β′ and α and α′ in each case are of equal magnitude (absolute value) in pairs and in which all baffles give rise to an axial direction of feed outwards for a given sense of rotation of the double-cone mixer, is especially preferred.

The axial conveying action according to the invention can not only be achieved with the baffles of type S1 and S2, but in some circumstances also with combinations of these types of baffles.

The size of the baffles is determined by their length (c), by their height (d), by their thickness (f) and by their distance from the wall of the mixing vessel (e) (cf. FIGS. 2 and 3). The arrangement on the wall of the mixing vessel is characterized by the ratio of segment (b) to segment (a).

The baffles within the scope of this invention have, as a ratio to the length of the wall of the mixing vessel (a), a length (c) that is typically 1.0*(a) to 0.15*(a), preferably 0.2*(a) to 0.8*(a), and especially preferably 0.3*(a) to 0.75*(a).

The height (d) of the baffles as a ratio to segment (L) of the mixing vessel is typically 0.01*(L) to 0.2*(L), preferably 0.02*(L) to 0.15*(L), and especially preferably 0.03*(L) to 0.1*(L).

A minimum thickness (f) of the baffles is predetermined by the mechanical strength of the material used (as a rule steel). In the case of enamelled baffles, additional manufacturing characteristics must be taken into account, for example relating to the permissible thermal expansion and specified minimum radii. A further increase in the thickness (f) of the baffles does not give any operational advantages. The thickness (f) is typically from 0.2*(d) to 0.5*(d).

The distance (e) of the baffles from the wall of the mixing vessel has an effect on the one hand on the mixing action and on the other hand on aspects of cleanability and residual emptying. In the case of enamelled baffles and double-cone mixers, special manufacturing characteristics must again be taken into account, which possibly require minimum dimensions. The distance (e) of the baffles from the wall of the mixing vessel is typically 10 mm to 250 mm, preferably 40 mm to 200 mm, and especially preferably 60 mm to 150 mm.

The ratio of segment (b) to segment (a) characterizes the arrangement of the baffles on the wall of the mixing vessel. Typical values for (b)/(a) are 0.1 to 0.9, preferably 0.2 to 0.8 and especially preferably 0.3 to 0.7.

Basically, the baffle proper is mounted on one or more feet (FIG. 2). Especially in the case of enamelled vessels, there are manufacturing limitations here, which are described for example in WO 2004/073847. For use in a double-cone mixer, preferably baffles with just one foot are used, which especially in the case of polysaccharide processing ensures good residual emptying and good cleanability.

The double-cone mixers according to the invention equipped in this way have volumes of typically 10 dm³ to 25 000 dm³, preferably 100 dm³ to 8000 dm³, and especially preferably 1000 dm³ to 6500 dm³.

Basically, embodiments of the double-cone mixers according to the invention both with and without internal lining are conceivable. In particular, with an enamel internal lining it is even possible to carry out process steps in which reactive and aggressive reactants and media are used, by means of such a mixer according to the invention.

The mixers according to the invention are especially suitable for the area of treatment and processing of solids. The double-cone mixers described above are particularly important in the production and processing of low-molecular polysaccharide derivatives, preferably based on starch or cellulose.

Another object of the present invention is therefore a method for the production or processing of low-molecular polysaccharide derivatives, in which a double-cone mixer of the kind according to the invention is used.

Suitable process steps in which such a mixer finds application are for example reduction of molecular weight by the action of if necessary gaseous acids such as hydrogen chloride.

Preferred polysaccharides are those based on starch and cellulose.

All the references described above are incorporated by reference in its entirety for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

We claim:

1. A double-cone mixer comprising a mixing vessel rotatable about an axis of rotation D comprising a drum with a cylindrical middle portion and a cone mounted on each open end of the cylinder, the mixing vessel having inside baffles, arranged so that they lead to mixing of product in an axial orientation relative to the axis of rotation D.

2. The double-cone mixer according to claim 1, wherein the mixing vessel is internally enamelled.

3. The double-cone mixer according to claim 1, wherein the number of baffles used is selected so that both cones each have the same number of baffles and within one cone baffles are arranged so that in equal-sized half-spaces, into which a cone is divided by a middle plane M that is perpendicular to the axis of rotation D, there is in each case the same number of baffles.

4. The double-cone mixer according claim 1, wherein the mixing vessel has a total of 2 to 8 baffles.

5. The double-cone mixer according to claim 1, wherein the baffles are arranged in the mixing vessel in such a way that an overall symmetrical arrangement is obtained, so that depending on the sense of rotation of the mixing vessel, product flows running in the axial direction caused by the baffles run either inwards towards the center of the mixing vessel, or with the opposite sense of rotation of the mixing vessel, outwards towards the wall of the mixing vessel.

6. The double-cone mixer according to claim 1, wherein the mixer has baffles of type S1 and S1′, which are arranged on the wall of the mixing vessel in alignment with the axis of rotation D and are rotated at an angle β or β′ relative to a middle line ML perpendicular to the axis of rotation and/or has baffles of type S2 and S2′, which in each case are positioned on a plane of projection AE that is rotated through angle α or in the case of S2′ through angle α′ relative to the axis of rotation D.

7. The double-cone mixer according to claim 6, wherein the pair of angles α and α′ or β and β′ are of equal magnitude (absolute value) and angles α and α′ are mathematically equal to each other and angles β and β′ are mathematically of opposite orientation to one another.

8. The double-cone mixer according to claim 6, wherein angles α and α′ have absolute values from 20° to 60° and angles β and β′ have absolute values from 15° to 50°.

9. The double-cone mixer according to claim 1, wherein the baffles have a length (c) from 0.3 to 0.75 times the length (a) of a wall of the mixing vessel, a height (d) from 0.03 to 0.1 times a segment (L) of the mixing vessel, a thickness (f) from 0.2 to 0.5 times the height (d), a distance (e) from the wall of the mixing vessel from 60 mm to 150 mm and a ratio of (b) to the length of the wall of the mixing vessel (a) from 0.3 to 0.7.

10. The double-cone mixer according to one claim 1, wherein the baffles are in each case attached by just one foot to the wall of the mixing vessel.

11. A method of processing of polysaccharide derivatives, which comprises using the double-cone mixer according to claim 1.

12. The method according to claim 10, wherein a polysaccharide or polysaccharide derivative is processed under the action of if necessary gaseous acids with reduction of the molecular weight.

13. The method according to claim 11, wherein the double-cone mixer is designed and operated in such a way that for a given sense of rotation of the mixing vessel, the flows running in the axial direction, caused by the baffles, run outwards towards the wall of the mixing vessel.
